(19) United States
(12) Patent Application Publication
(10) Pub. No.: US 2019/0114681 A1
(43) Pub. Date: Apr. 18, 2019

(54) System for Publicly Raising Funds from Investors Without a Security

(71) Applicants: Mark Laurence Donald Emerson, Las Vegas, NV (US); Jonathan Richard Emerson, Culver City, CA (US); David Laurence Emerson, Woodinville, WA (US)

(72) Inventors: Mark Laurence Donald Emerson, Las Vegas, NV (US); Jonathan Richard Emerson, Culver City, CA (US); David Laurence Emerson, Woodinville, WA (US)

(21) Appl. No.: 16/153,791

(22) Filed: Oct. 7, 2018

Related U.S. Application Data
(60) Provisional application No. 62/572,028, filed on Oct. 13, 2017.

(51) Int. Cl. G06Q 30/02; G06Q 40/06; G06Q 20/04

(52) U.S. Cl. CPC G06Q 30/0279; G06Q 30/0241; G06Q 20/0453; G06Q 40/06

(57) ABSTRACT

A business method for a primary nonprofit entity (PNE) to raise capital to finance a money-making project that benefits humanity by publicly raising funds from investors without involving a “security” and hence without invoking the jurisdiction of federal or state securities regulators. In lieu of securities, investors purchase “hearts” from the PNE. Hearts entitle their owner to direct the distribution of a proportionate amount of grant funds paid by the PNE to secondary nonprofit entities (SNEs). When and if the PNE's project is financially successful, it pays investment returns as grants to the SNEs as directed by each heart holder, respectively, in proportion to his or her hearts. The business method additionally includes a means for the PNE to partner with a for-profit entity (FPE) in a manner that integrates the shares of stock issued by the FPE (which are securities) with the hearts issued by the PNE (which are not), so that the amount of grants paid per heart equals the amount of (pre tax) dividends paid per share.

### CROSS-REFERENCE TO PROVISIONAL PATENT APPLICATION

This nonprovisional patent application is made in reference to the provisional patent application with the same title by the same inventors filed on 13 Oct. 2017 at 15:18:41 Eastern Time, Application Number 62572028, EFS ID 30652836, Confirmation Number 5383.

### NOTICE RE NAME CHANGE OF THIRD INVENTOR

Between the time that said provisional patent application was filed and the time this non-provisional patent application is being filed, the third inventor legally changed his name from David Laurence Emerson to David Moksha. This patent application is being electronically filed, and the Application Data Sheet references the provisional application. To avoid triggering an electronic filing error from a mismatch in inventor names, and acting in good faith, said inventor is using his former name on the Application Data Sheet, his inventor oath (form AIA/01) and his certification of micro entity status (form SB/15A) that are being filed herewith. The inventors respectfully request guidance from USPTO as to any amendment form that may need to be filed in connection with the name change.

### BACKGROUND OF THE INVENTION

The primary way that businesses raise capital from investors is by selling the investors “securities,” typically shares of stock.¹ However, for the purpose of protecting investors, state and federal securities laws impose severe restrictions on the offer and sale of securities by companies needing to raise capital. Within the United States, these restrictions are complex and vary from state to state, and, if interstate commerce is involved, federal securities laws also apply. ¹ See, e.g. 15 U.S. Code § 77b, listing numerous instruments defined to be “securities” under the Securities Act of 1933.

The primary motivation for investment in securities is the prospect of making a profit. Indeed, an indispensable characteristic of every security is the potential for the owner of the security to receive money or other valuable assets (a) from the issuer of the security, such as dividends on a stock or interest payments on a bond, and/or (b) upon the issuer's dissolution. A security owner might also be able to sell the security to another person, either directly or through a securities exchange, but its sale value ultimately rests on its inherent value based on the indispensable characteristics in (a) and (b) above.

In the U.S., the federal government and all states (with certain exceptions in New York) require (a) registration of securities offered or sold or an exemption from registration, and (b) registration of brokers, dealers, agents and/or sales representatives who “effect” sales of securities. With registration, a company can generally sell its stock publicly to any investor who is interested. However, the process of obtaining registration is complex, prohibitively costly for small companies, and, even if the cost is mounted, is not guaranteed to result in registration. Generally, small companies instead rely on exemptions from registration.

Such exemptions from registration generally require that the security either (a) is not sold publicly (meaning the investment offering cannot be advertised to the public—investors must have a private connection to the company)—see, e.g. 15 U.S.C. § 77d(a)(2), exempting “transactions by an issuer not involving any public offering,” or (b) is sold exclusively to wealthy individuals who qualify as “accredited investors” (thereby excluding the vast majority of people who might wish to invest)—see, e.g. 15 U.S.C. § 77d(a)(2)(5)², or (c) [recently added by the Jumpstart Our Business Startups (JOBS) Act of 2012, including at 15 U.S.C. § 77d(a)(2)(6)] is sold through a “crowd funding portal” that is licensed in that role by federal securities regulators (where the portal typically collects a fee, based on a percentage of the investments received, before paying the balance to the company). While (a) and (b) have fairly minimal procedures for complying with the exemptions involved, crowd funding portals impose substantial compliance requirements on companies, and additionally, the companies must make periodic reports to federal securities regulators. ² It is the opinion of the inventors that exemptions in securities laws for “accredited investors” unconstitutionally discriminate on the basis of economic class by conferring a special privilege on the wealthy class. These exemptions exclude non-wealthy people from lucrative investment opportunities, notwithstanding that some non-wealthy people may (a) be fully capable of evaluating the risks of an investment, and (b) wish to prudently invest an amount they can afford to lose. Securities laws “protect” non-wealthy people by excluding them entirely from such opportunities. In striking contrast, non-wealthy and impoverished people are permitted to purchase lottery tickets sold by governments (and to gamble where gambling is legal), with no limitation on the amount played or gambled (even their entire paychecks or savings), with no requirement that they be capable of assessing the risk of loss, including the risk of devastation to their families.

In the U.S. nonprofit sector, money-making projects are sometimes operated by nonprofit entities, typically corporations, with the resulting monies being used to fund philanthropic or humanitarian activities. However, if such projects require capital, nonprofit corporations cannot raise it by selling stock, and this is for two reasons. First, state incorporation laws generally prohibit nonprofit corporations from selling stock—see Nevada's NRS § 80.136(a) providing that a nonprofit corporation “must not have or issue shares of stock.” Second, if returns were to be paid to the stockholders of a nonprofit, that would constitute “private inurement” which would undermine the corporation's tax-exempt status—see 26 U.S.C. § 501(c)(3).

Instead, the primary way that nonprofit entities raise money is from donations, which are solicited from a wide variety of sources. Many states (but not the federal government) have charitable solicitation laws that regulate the solicitation of donations to protect donors. Some states require nonprofit entities to register to solicit donations, but there are various exemptions from registration. In general, state charitable solicitation laws are substantially less onerous than securities laws, and, depending upon how a nonprofit entity is organized and operated, exemptions from registration are available in most states. Charitable solicitation laws are mentioned here for the sole purpose of full disclosure to prospective practitioners of the embodiment described herein, but organizational methods for compliance with or exemption from these laws are not addressed in this patent application.

### BRIEF SUMMARY OF THE INVENTION

The first embodiment (“Embodiment One”) is a business method that enables a nonprofit entity (the “Primary Nonprofit Entity” or “PNE”), which seeks to raise capital for a project that serves legitimate nonprofit purposes (e.g. creating and selling educational products) and that is also anticipated to make money, (a) to publicly raise funds to finance the project from investors without discriminating on the basis of the investors' economic class, (b) when and if the project is financially successful, to pay investment returns in a manner that is mathematically analogous, but not legally analogous, to a for-profit corporation paying investment returns in the form of dividends in proportion to shares of stock, where the number of shares an investor owns is based on the amount invested and the share price at the time of investment, (c) to accomplish (b) by paying returns in the form of grants to other nonprofit entities (each a “Secondary Nonprofit Entity” or “SNE”) designated by investors, and (d) to accomplish the foregoing without issuing any “security” and hence without invoking the jurisdiction of federal or state securities regulators. The project is targeted to sell products or services whose sale falls within the nonprofit purposes of the PNE.

The embodiment replaces the traditional for-profit investment unit of a “share of stock” with a new nonprofit investment unit called a “heart.” The PNE raises capital by offering, selling and issuing hearts to investors. The price per heart is generally set in advance by the PNE based on the maturity and overall value of the project at the time of the investment offering, but can also be negotiated with investors. The heart offering can be publicly advertised. The PNE can also issue hearts in exchange for services, including to its principals. The hearts give their owner the right to direct the PNE to distribute a proportionate amount of grant funds to one or more SNEs. Thus, when the PNE makes a distribution of monies generated by its successful project, the distribution is typically split into separate grants to each SNE, in proportion to the hearts.

The heart owner can change his or her designation of hearts to SNEs from time to time by informing the PNE. If the heart owner wishes to direct grant funds to multiple SNEs, he or she informs the PNE of how many hearts are to be designated to each SNE.

The second embodiment (“Embodiment Two”) is a business method by which the PNE (described above in Embodiment One) partners with a For-Profit Entity (“FPE”), which has issued shares of its stock to stockholders, to jointly finance and implement a money-making project, so that distributions arising from the project's financial success are apportioned between the hearts and the shares by a formula that causes the grant amount paid on each heart to equal the dividend amount paid on each share (“Heart/Share Payout Equivalence”). However, the resulting dividends per share are somewhat less than grants per heart because of corporate income tax the FPE pays (the PNE is tax exempt). The intellectual property associated with the project (“IP”) is owned by the FPE (and if not yet owned by the FPE, then the IP is lawfully conveyed to the FPE).

Embodiment Two is useful when an enterprise, which was originally organized as a FPE and has issued shares of stock (e.g. to founders and to investors who contributed capital), wishes to reorganize so that it can raise additional capital by selling hearts. The new capital can be used to fund product development work (e.g. software development) and other activities done by employees of the PNE—however, for legal reasons explained below, the IP created by that effort must be transferred to the FPE. Although the FPE can give its stockholders the opportunity to convert their shares to hearts, it cannot force them to do so—Embodiment Two permits the shares of stock to remain intact and harmonizes stock and hearts.

The third embodiment (“Embodiment Three”) is a business method identical to Embodiment Two except that the IP is conveyed from the FPE to a separate entity (“IP Holding Entity” or “IPHE”). The reason for isolating the IP is to protect it from lawsuits that might arise from product sales activities by the PNE or FPE.

Additional potential embodiments are briefly mentioned.

### BRIEF DESCRIPTION OF DRAWINGS

FIG. 1 shows Embodiment One.

FIG. 2 shows a Heart Certificate.

FIG. 3 shows formulas for Embodiment One.

FIG. 4 shows a computer, a table and a flow chart for Embodiment One.

FIG. 5 shows a flow chart and a table for Embodiment One.

FIG. 6 shows a traditional for-profit corporation.

FIG. 7 shows Embodiment Two.

FIG. 8 shows formulas and monetary flows for Embodiment Two.

FIG. 9 shows the pertinent portion of Embodiment Three.

### DETAILED DESCRIPTION OF THE EMBODIMENTS OF THE INVENTION

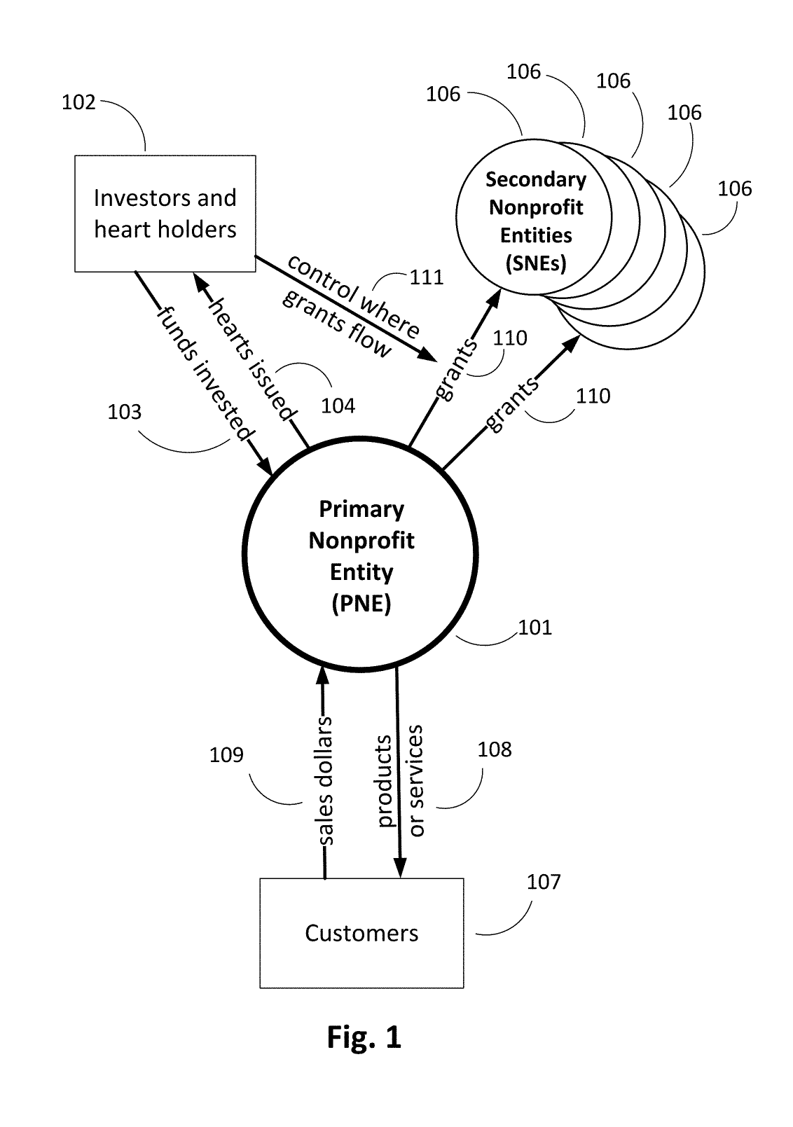

Embodiment One is shown in FIG. 1. The PNE, 101, seeks to raise capital for a money-making project. Investors, 102, pay their investment funds, 103, to the PNE, and the PNE issues hearts, 104, to the investors. The number of hearts issued is equal to the dollar amount invested divided by the price per heart, where the price is either set by the PNE or negotiated between the investor and the PNE. Hearts may also be issued to additional people, 102, for their non-monetary contributions to the project. Each person to whom hearts are issued receives a heart certificate from the PNE documenting the transaction. One or more SNEs, 106, will be the ultimate beneficiaries.

When the project is ready for marketing, customers, 107, purchase the products or services arising from the project, 108, from the PNE, paying their sales dollars, 109, to the PNE.

When the PNE has earned enough money from the project to distribute funds on the heart investments, it pays that distribution as grants, 110, to the SNEs. Periodic distributions can be made as the project continues to make money. The heart holders, 102, control, 111, how each distribution is apportioned into grants to the various SNEs as set forth below.

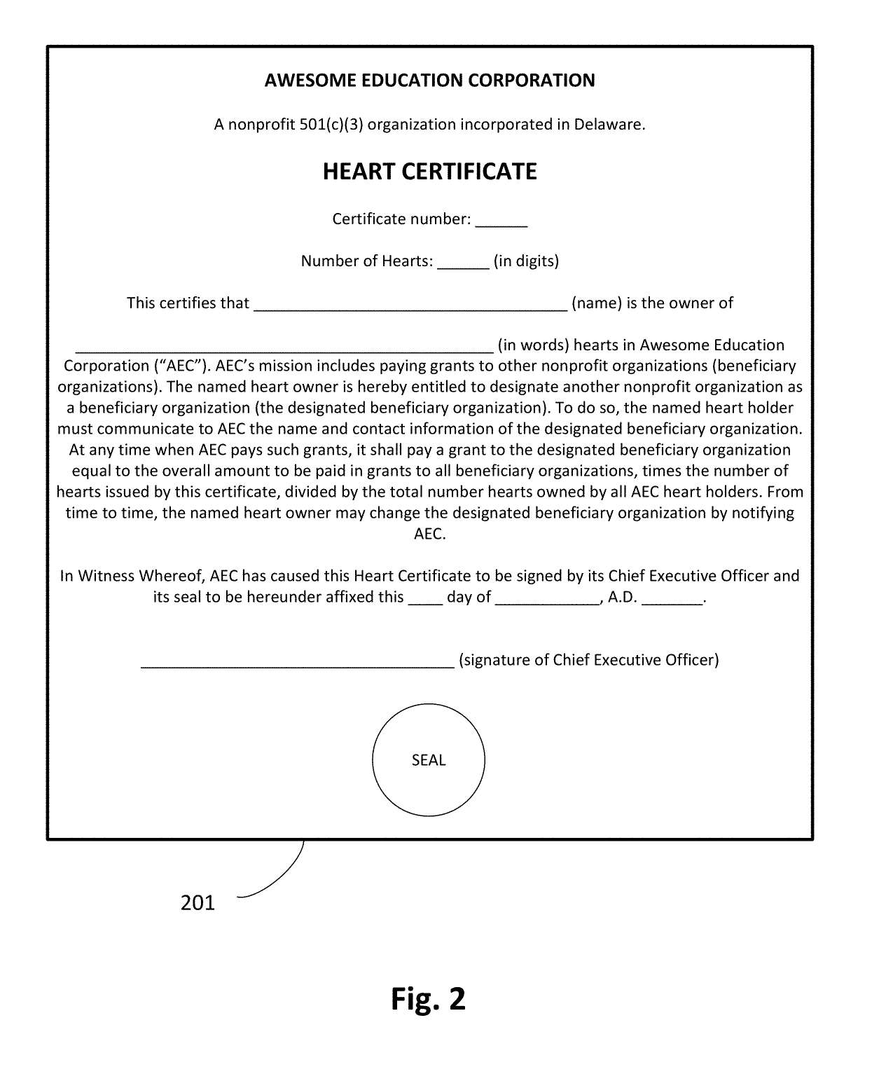

FIG. 2 sets forth an example form of a heart certificate, 201, which includes the name of the PNE, the certificate number, the number of hearts issued, the name of the person to whom they are issued (i.e. the heart owner, also known as the heart holder), a description of the meaning of the hearts and the rights of the owner, the date of issuance, and a certification by the PNE.

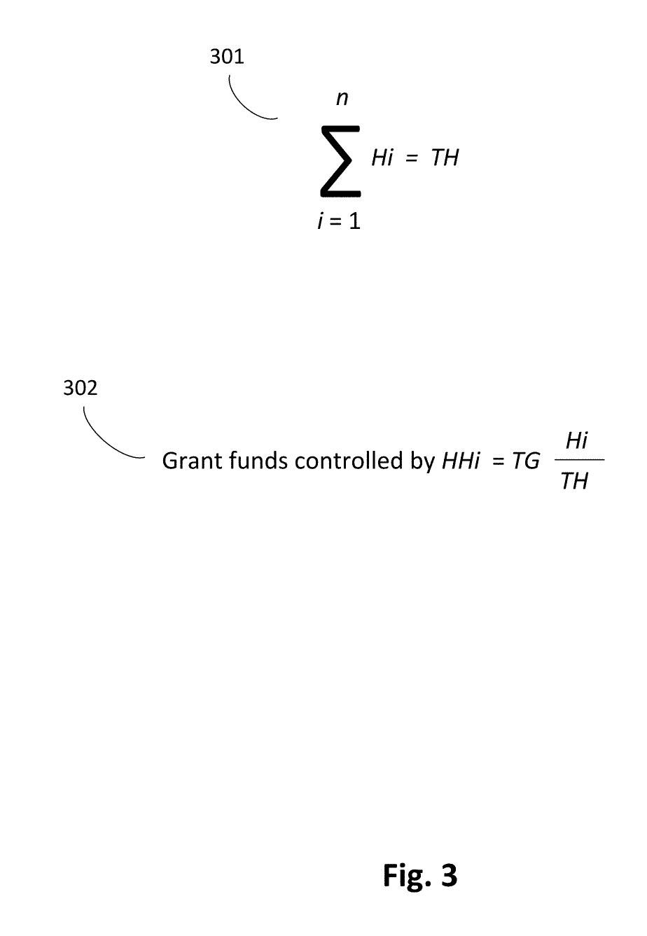

FIG. 3 sets forth the formulas for a particular distribution, where the total grant funds distributed is TG, the total number of hearts held at that time by the heart holders is TH, the heart holders at that time are HH1, HH2, . . . HHn, where n is the total number of heart holders, and Hi is the number of hearts held by an arbitrary heart holder, HHi. Therefore, the equation set forth at 301 holds. Now, by the embodiment, the amount of grant funds within TG that are controlled by a heart holder, HHi, is set forth in the equation at 302. This means the grant money each heart holder controls is proportional to his or her hearts. By mathematical analogy (but not legal analogy), when a for-profit corporation pays dividends, the amount received by each stockholder is proportional to his or her shares. Each heart holder informs the PNE of which SNE he or she is designating to receive the grants funds under the heart holder's control. Such SNE is alternatively called the Designated Beneficiary Organization. A heart holder may also designate multiple SNEs, and in that case informs the PNE of how many hearts are designated to each SNE, with the total number hearts designated not exceeding the number of hearts the heart holder owns.

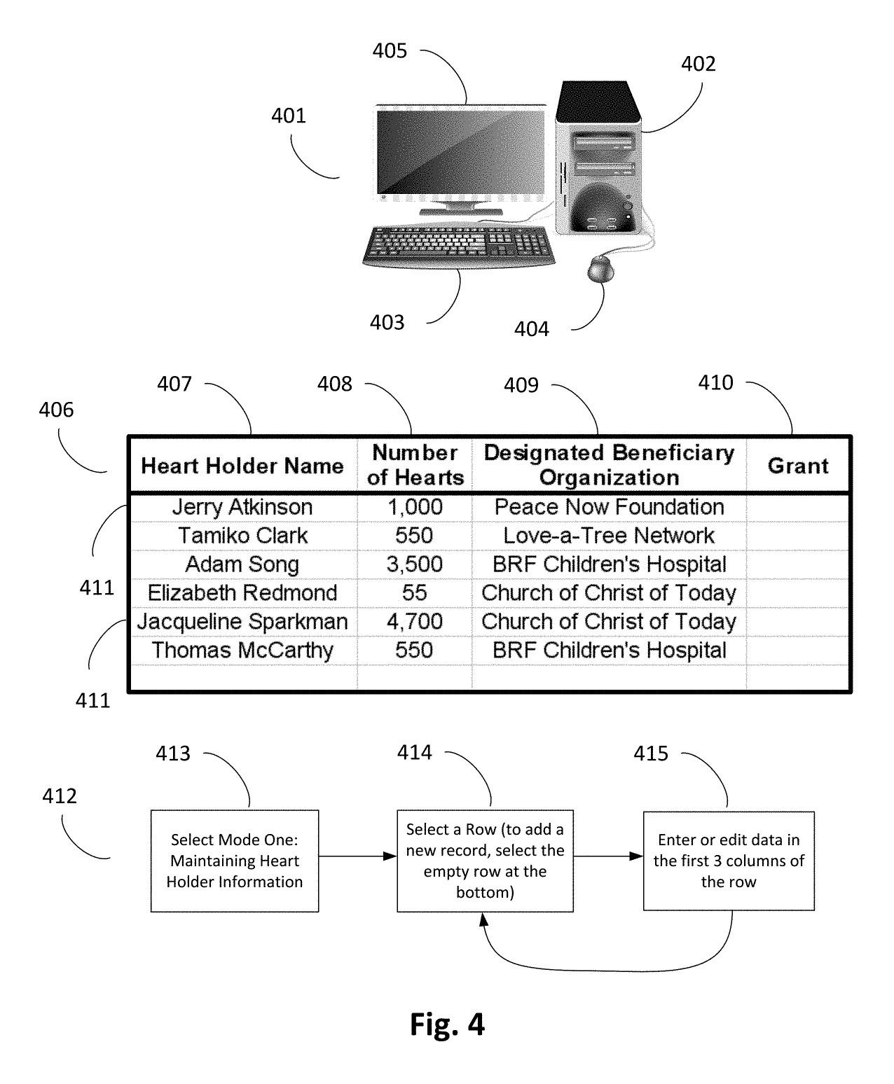

FIG. 4 sets forth the method used by the PNE for calculating the grants to be paid to the SNEs, based on the foregoing formulas (in FIG. 3). The version of the program described here assumes (for simplicity) that each heart holder designates just one SNE to receive the grants he or she controls with his or her hearts.

The calculation is done using a personal computer, 401, comprised of a tower, 402 (containing a mother board, a processor such as a Pentium chip, memory, a hard drive, and input/output ports), a keyboard, 403, a mouse, 404, and a display, 405. (Alternatively, the calculation could be programmed as an “app” that runs on a smart cell phone, or on a server computer.) The computer, 401, is programmed with software to facilitate entry of records (rows) into a table, 406, with the following columns: Heart Holder Name, 407, Number of Hearts, 408, Designated Beneficiary Organization (i.e. SNE), 409, and Grant, 410. Each row, 411, in the table, shows the name, number of hearts and designated SNE for one heart holder.

The program has two modes. The operation of Mode One is shown in a flow chart, 412. It enables the user, who works for the PNE, to enter the name, number of hearts and designated SNE of each heart holder, and to change this information. However, it does not permit the user to enter anything in the Grant column. To use Mode One, the user begins by selecting Mode One, 413, whereupon the program changes to another state, wherein the user sees the table and selects a row in the table, 414. If the user wants to edit the data for a heart holder already in the table, then he or she selects that row. If the user wants to add a new heart holder, then he or she selects the empty row at the bottom. Then the program changes state to enable the user to edit or input the desired data, 415. However, the program does not permit the user to enter any data in the Grant field, 410. When the user is finished editing the data in a row (or entering data in the bottom row to create a new row), indicated by pressing a particular key, then the program changes its state back to the prior state, 414.

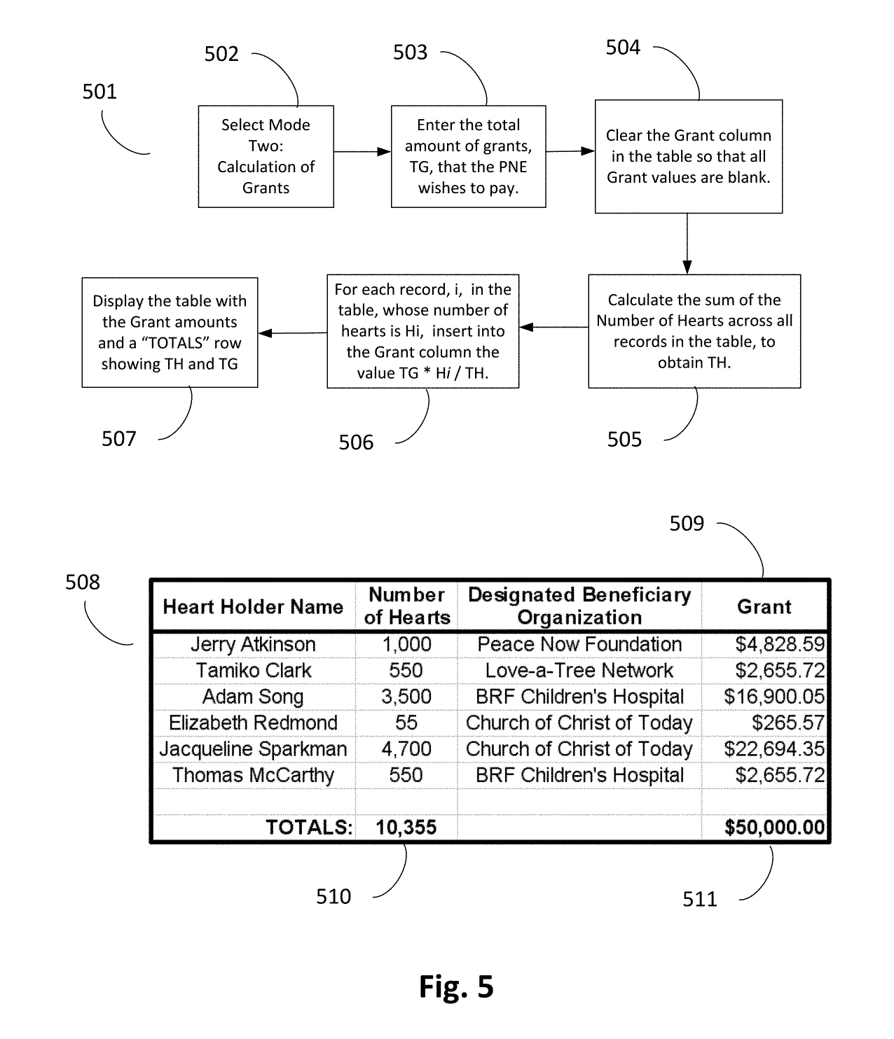

The operation of Mode Two of the program is shown in FIG. 5. It enables the user, who works for the PNE, to enter the total amount of grant money, TG, that the PNE intends to distribute to its SNEs, whereupon the program automatically calculates the amount of grant paid to each SNE. To use Mode Two, the user begins by selecting Mode Two, 502, whereupon the program changes to an other state, 503, where the user is prompted to enter the total grants, TG. In the example shown, the user inputs $50,000 for the total grants. Then, if the Grant column is not already clear, the program clears it, 504, to make all the Grant values blank. The program then calculates the sum of all the hearts in the table, 505, to obtain TH as discussed above and shown in 301. Next, 506, the program inserts the Grant value for each row in the table, which, as discussed above and shown in 302, is TG*Hi/TH, where Hi is the number of hearts in that row. Lastly, 507, the program displays the table for the user to view, 508, with the Grant column, 509, filled in, and at the bottom inserts the totals: TH, 510, and TG, 511.

Hearts are not “securities” because they lack the indispensable characteristic of a security. Specifically, they lack the potential for the heart holder, 102, to receive money or other valuable assets from the issuer of the security or upon the issuer's dissolution. This is because the grants are not paid back to the heart holder, but rather are paid to a nonprofit SNE, 106. Nor do hearts have any monetary value to the heart holder, but rather constitute a charitable power to direct, 111, grant funds, 110, for the nonprofit purposes of the SNEs, 106. Indeed, the investment that purchases the hearts, 103, is actually donated to the PNE. Donations are not protected by securities laws.

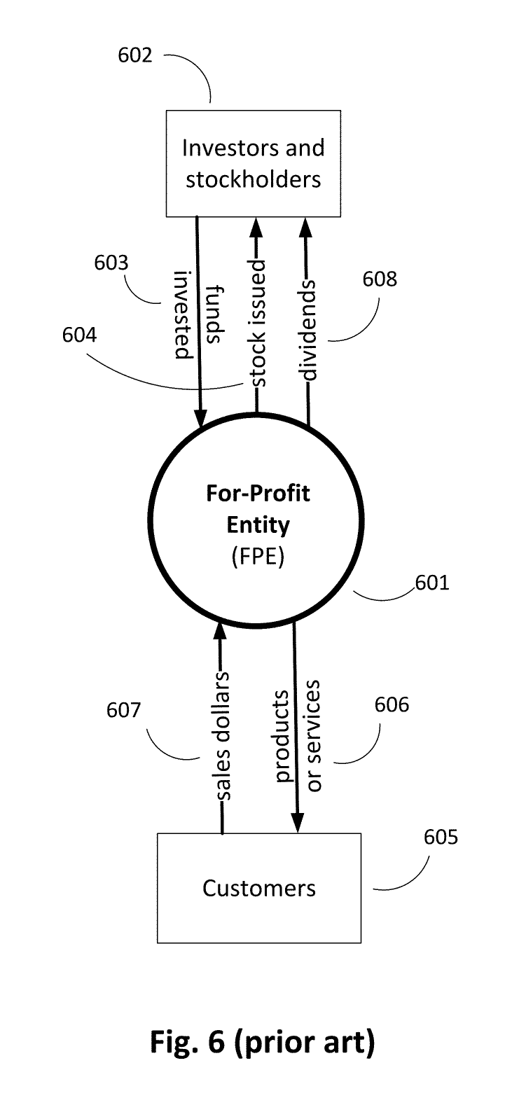

Before describing Embodiment Two, FIG. 6 is presented showing a traditional means of financing a business project (not claimed as an embodiment herein, but set forth for subsequent reference) wherein investors purchase the stock of a FPE (usually a corporation) with the hope of receiving investment returns via dividends. The FPE, 601, offers its stock to investors, 602, who invest funds, 603, in to the FPE, and the FPE issues shares of its stock, 604, to them in exchange. Typically, some stockholders, 602, receive stock for their services rather than for invested funds. When the project is ready for marketing, customers, 605, purchase products or services arising from the project, 606, from the FPE, paying their sales dollars, 607, to the FPE. When the FPE is successful, it can distribute dividends, 608, to the stockholders in proportion to the number of shares each one owns.

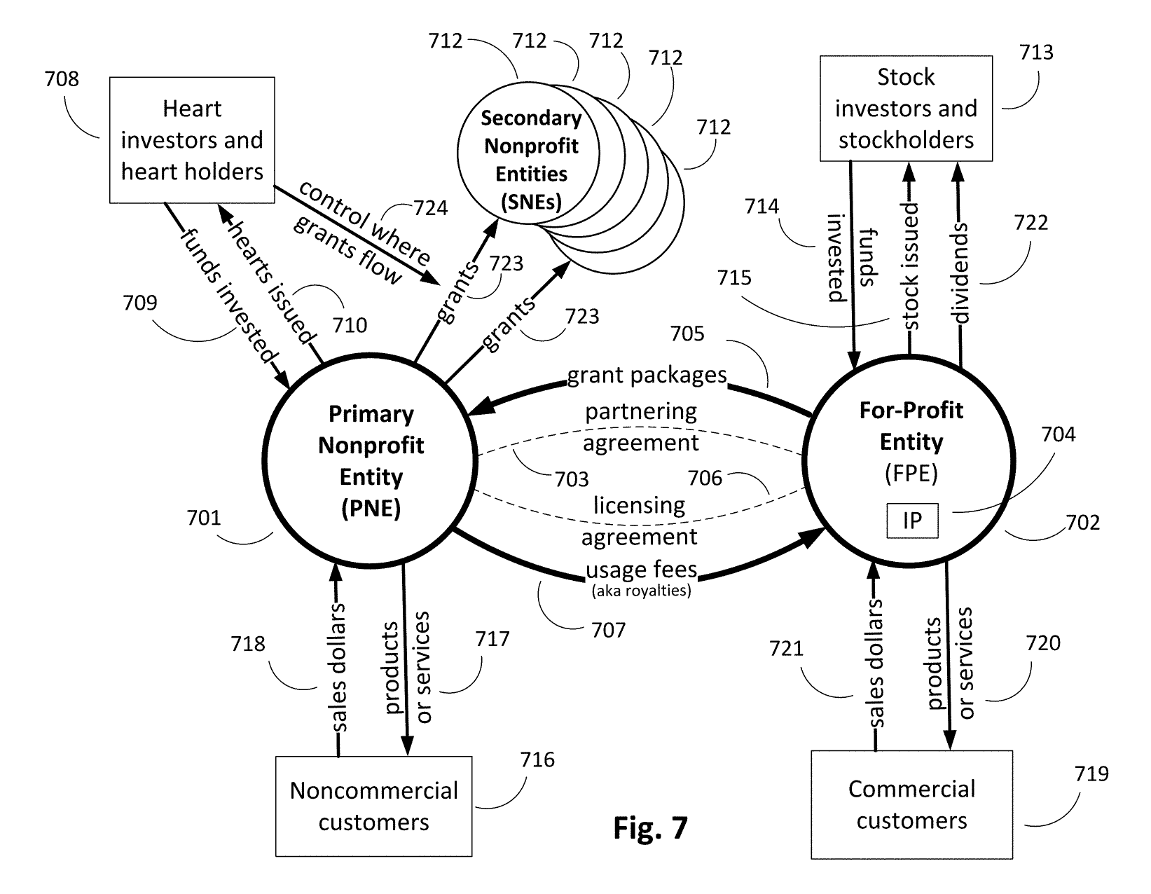

Embodiment Two is shown in FIG. 7, which integrates FIG. 1 and FIG. 6. The PNE, 701, and the FPE, 702, enter into a partnering agreement, 703, which provides (a) for them to work together on a money-making project, (b) for the IP associated with the project, 704, to be ultimately owned by the FPE, and for any project IP created by the PNE (presumably by efforts funded by heart investments) to be transferred to the FNP, (c) for the FPE to pay grant packages, 705, to the PNE in consideration for IP conveyed to the FPE, and (d) for the PNE and FPE to lend capital to each other as needed. The grant packages are structured to support one side of the Heart/Share Payout Equivalence, as discussed below.

After executing the partnering agreement, the PNE and FPE enter into a separate licensing agreement, 706, in which the FPE gives the PNE an exclusive license to sell products or services containing the IP to noncommercial customers, reserving for the FPE the right to sell such products or services to commercial customers. By selling primarily to noncommercial customers, the PNE is more likely to operate within the requirements of its tax-exempt status. In consideration for the license, the PNE agrees to pay usage fees, also known as (“aka”) royalties, 707, to the FPE. The usage fees are structured to support the other side of the Heart/Share Payout Equivalence, as discussed below.

As in Embodiment One, heart investors, 708, invest funds, 709, into the PNE, which issues hearts, 710, back to the investors. Other people, 708, can also be issued hearts for services, including developing the IP—however, IP developed by the PNE is then conveyed to the FPE under the partnering agreement, 703. One or more SNEs, 712, will be the ultimate beneficiaries of the grants from PNE.

The FPE can also raise funds for the project from investors, 713, who invest funds, 714, into the FPE, which then issues stock, 715, to the investors. Also, the FPE may have pre-existing stockholders from the time before formation of the partnership with the PNE, 713. However, the stock is a security, so the sale of the stock to investors must comply with securities laws.

Using the combined capital raised by the PNE from the sale of hearts, and by the FPE from the sale of stock, the project proceeds under the partnering agreement. When the project is ready for market, noncommercial customers, 716, purchase the resulting products or services containing the IP, 717, from the PNE, paying their sales dollars, 718, to the PNE. And commercial customers, 719, purchase products or services containing the same IP, 720, from the FPE, paying their sales dollars, 721, to the FPE.

As explained in greater detail below, when the project is financially successful, and the FPE makes a distribution, it is split into a stock portion and a heart portion. The stock portion is paid as a dividend, 722, to the stockholders, 713, and the heart portion is paid as a grant package, 705, to the PNE, which, in turn, pays the grant package out as grants, 723, to the SNEs, 712, under the control, 724, of the heart holders in the manner set forth in Embodiment One. When the PNE makes a distribution, it is likewise split into a stock portion and a heart portion. The grant portion is paid out as grants, 723, to the SNEs, 712, under the control, 724, of the heart holders in the manner set forth in Embodiment One, and the stock portion is paid as a usage fee (aka royalty), 707, to the FPE, which, in turn, and after setting aside corporate income tax payable on the usage fee, pays the balance of the usage fee as a dividend, 722, to the stockholders, 713.

Generally Accepted Accounting Principles (“GAAP”) require a corporation to pay dividends from its retained earnings. This patent application assumes the FPE will set the dividend funds aside from its general retained earnings account into a separate retained earnings account, called “provisional dividends.” (A GAAP compliance check should be done before making actual payment of the dividends to stockholders to ensure that the FPE's overall retained earnings do not come out negative.)

The calculations made in connection with Embodiment Two are done on a computer, 401, in a manner similar to the program illustrated for Embodiment One, except that additional calculations are made as explained below. The description below is sufficient for a skilled programmer to create the program. It is also possible for the PNE and FPE to each have their own computer systems, with information shared between the two systems that is necessary for the operation of Embodiment Two.

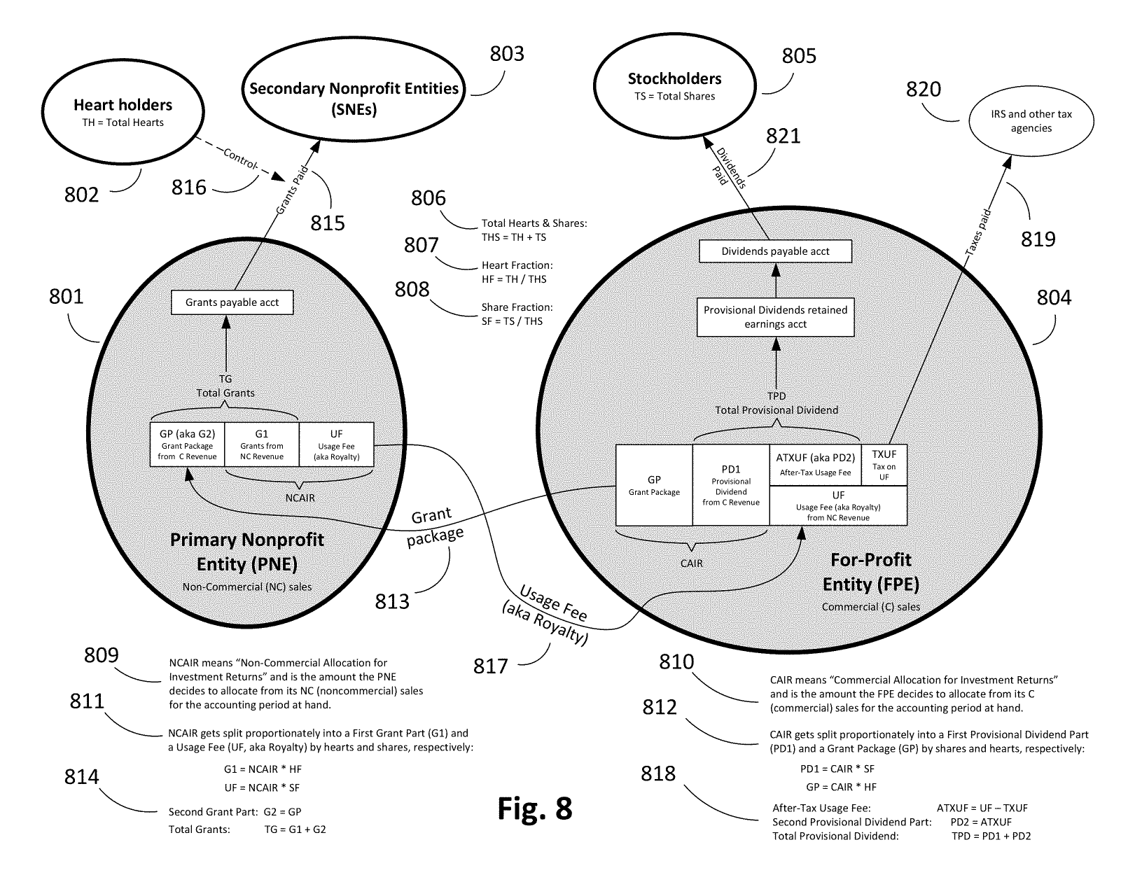

Allocations and distributions made by the FPE and by the PNE are diagrammed in FIG. 8, which shows the PNE, 801, the heart holders, 802, the SNEs (grouped as a single ellipse), 803, the FPE, 804, and the stockholders, 805. TH, 802, is the total number of hearts, and TS, 805, is the total number of shares. The total hearts and shares THS, 806, is the sum of TH and TS. The heart fraction, HF, 807, is TH divided by THS, and the share fraction, SF, 808, is TS divided by THS.

The PNE and FPE synchronize their accounting periods and coordinate the following calculations. At the close of each period, (a) the PNE determines an amount it wishes to allocate to investment returns on the shares and hearts from its noncommercial business, which is called its “Non-Commercial Allocation for Investment Returns” (“NCAIR”), 809, and (b) FPE determines an amount it wishes to allocate to investment returns on the shares and hearts from its commercial business called its “Commercial Allocation for Investment Returns” (“CAIR”), 810. Both NCAIR and CAIR will be based on the PNE's and the FPE's respective financial statuses and policies, as well as GAAP, and either may be zero. Once NCAIR and CAIR have been decided, the rest of the calculations (except for the tax on usage fees) follow automatically and in the following sequence.

Step 1. NCAIR is split proportionately, 811, between hearts (HF) and shares (SF), into a First Grant Part, G1 (which constitutes the PNE's contribution to its own grants), and the Usage Fee, UF, aka royalty (which constitutes the PNE's contribution to provisional dividends, before taxes, to be paid by the FPE), where:

G1=NCAIR*HF

and

UF=NCAIR*SF

Thus, at the conclusion of Step 1, the values of G1 and UF are known.

Step 2. CAIR is split proportionately, 812, between shares (SF) and hearts (HF), into a First Provisional Dividend Part, PD1 (which constitutes the FPE's contribution to its own provisional dividends), and a Grant Package, GP (which constitutes the FPE's contribution to grants to be paid by the PNE), where

PD1=CAIR*SF.

and

GP=CAIR*HF.

Thus, at the conclusion of Step 2, the values of PD1 and GP are known.

Step 3. The calculation and payment of grants by the PNE are done as follows. First, FPE makes a payment to the PNE in the amount of the Grant Package, GP, 813. GP constitutes the second of two grant parts; therefore, for clarification here in this description of Embodiment Two, GP is also known as G2, 814. (However, in the Claims below, it is known only as the grant package, GP.) This results in the total amount of grant funds, TG, 814, being the sum of the two grant parts:

TG=G1+G2.

Then, the PNE distributes TG, 815, to the SNE's under control of the heart holders, 816, as explained above in Embodiment One. At the conclusion of Step 3, all the grants have been paid to the SNEs for the accounting period.

Step 4. The calculation and setting aside of provisional dividends by the FPE are done as follows. First, the PNE makes a payment to the FPE in the amount of the Usage Fee, UF, 817. Then, the FPE determines the amount of its corporate income tax attributable to the Usage Fee, TXUF, which is subtracted from UF, to obtain the After-Tax Usage Fee (“ATXUF”), 818:

ATXUF=UF−TXUF

ATXUF constitutes the second of two provisional dividend parts; therefore, for clarification here in this description of Embodiment Two, ATXUF is also known as PD2, 818. (However, in the Claims below, it is known only as the after-tax usage fee, ATXUF.) This results in the total amount of provisional dividends, TPD, 818, being:

TPD=PD1+PD2.

The FPE then pays the tax, TXUF, 819, to the IRS and other tax agencies, 820, and sets aside TPD for payment as a dividend. TPD is then paid as a dividend to the stockholders, 821. At the conclusion of Step 4, all the dividends have been paid for the accounting period.

The PNE should determine NCAIR in such a way that it can immediately pay (1) the resulting UF to the FPE, and (2) the resulting G1 in grants to the SNEs, while leaving sufficient cash for operations, and appropriately managing any debt. NCAIR excludes grant package (GP) revenue received from the FPE. If the PNE has broad humanitarian purposes, and the SNEs each support those broad purposes in some specific way, then both the grants and the usage fees can be treated as expenses to the PNE that are not paid from its net earnings, because their payment is done in furtherance of its broad purposes.

The FPE should determine CAIR in such a way that it can immediately pay (1) the resulting GP to the PNE, and (2) the resulting PD1 can be declared as a dividend in accordance with GAAP and then paid to the Stockholders, while leaving sufficient cash for operations, sufficient retained earnings, and appropriately managing debt. CAIR excludes usage fee (UF) revenue received from the PNE.

There are two legal reasons that IP developed by the PNE must be transferred to the FPE, 704. The first is so that the stockholders of the FPE receive fair consideration for payment of the grant packages, 705, to the PNE. The second is to provide a basis for PNE to make regular payments (royalties), 707, to the FPE that are permissible under nonprofit law.

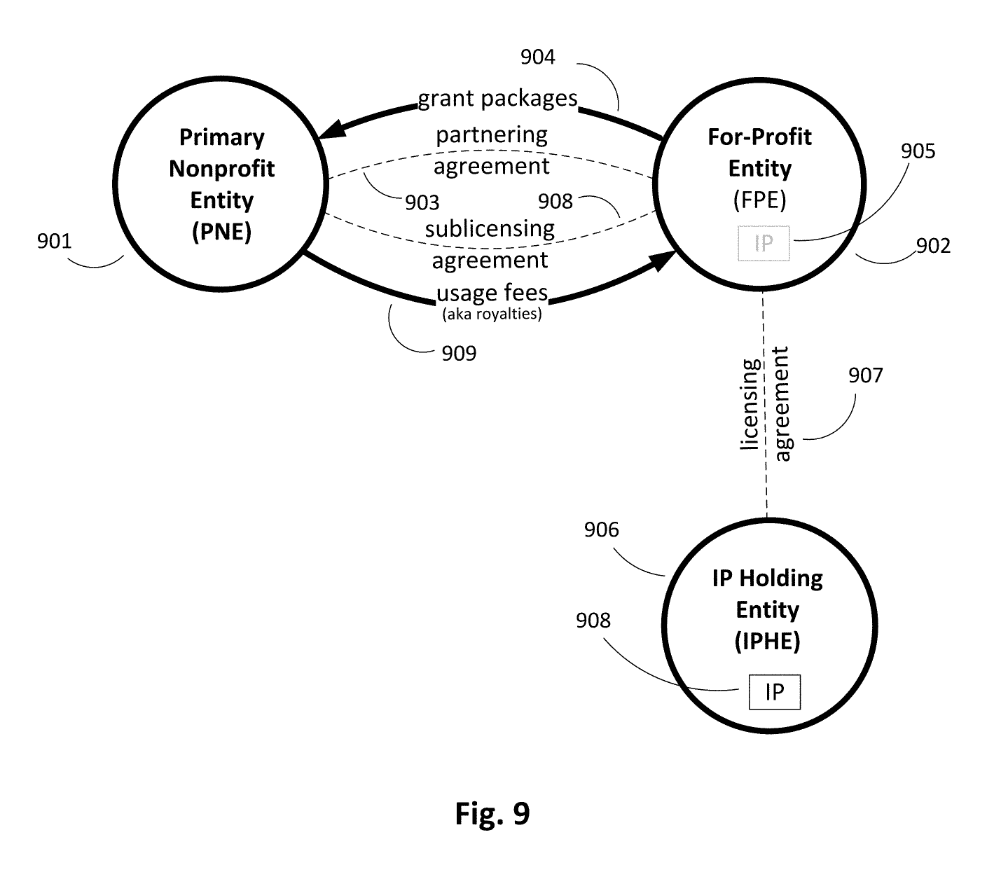

Embodiment Three is a variant of Embodiment Two, wherein the IP is owned by a separate entity, the IPHE, with the differences shown in FIG. 9. As in Embodiment Two, the PNE, 901, and the FPE, 902, execute a partnering agreement, 903, providing for the payment of grant packages, 904, and after its execution, all the IP is owned by the FPE, 905.

Then, the FPE and the IPHE, 906, execute a licensing agreement, 907, whereby the IP is conveyed from the FPE, 905, to the IPHE, 908, in exchange for the IPHE granting the FPE a permanent, exclusive license to the IP for all purposes. The IPHE should not conduct any business of developing or marketing the IP, because doing so would undermine the lawsuit protection afforded by the embodiment.

Finally, the PNE and FPE execute what is now a sublicensing agreement, 908, in the same form as the licensing agreement, 706, in Embodiment Two but with the word “license” changed to “sublicense,” granting the PNE an exclusive sublicense to sell products or services containing the IP to noncommercial customers, in exchange for royalties, 909, while reserving for the FPE the right to sell such products or services to commercial customers.

Additional Embodiments are possible that combine the PNE and FPE to achieve the purposes of Embodiments Two and Three.

One such embodiment could use real property, facilities and/or equipment in lieu of IP. In such case, the license (and sublicense) could be replaced with a lease (and sublease), royalties replaced with rents, and the IPHE replaced with an entity that owns such property. Alternatively, manufacturing could be done by the FPE, and the PNE could purchase finished products from the FPE, in lieu of paying royalties or rents.

In another such embodiment, the FPE could be a for-profit entity other than a corporation, such as a partnership, a limited liability company or another type of entity. In such case, shares of stock in the FPE could be replaced with ownership interests appropriate to the type of entity.

1. A system for raising funds by selling investment units to investors, and subsequently paying investment returns on the basis of such units, that does not involve a security; a security being a share of stock or other investment unit regulated by securities laws; an indispensable characteristic of a security being the potential for the owner of the security to receive money or other valuable assets from the issuer of the security or upon the issuer's dissolution; the system for raising funds comprising:
(a) a plurality of nonprofit legal entities; each nonprofit legal entity being a nonprofit corporation, a nonprofit trust, a nonprofit association or another kind of nonprofit legal entity; one of the nonprofit legal entities being a primary nonprofit entity, which is hereinafter identified by the acronym PNE; the remaining nonprofit legal entities each being a secondary nonprofit entity, which are hereinafter identified individually by the acronym SNE and collectively by the pluralized acronym SNEs;
(b) one or more hearts; a heart being an investment unit comprising a right to control a portion of a distribution of nonprofit grants;
(c) a means for the PNE to conduct a heart investment offering through which investors may purchase one or more hearts comprising three steps:
(1) determination of a heart price denominated in dollars per heart or another monetary unit per heart;
(2) payment of money by an investor to the PNE, the payment comprising an investment in hearts at the heart price; and
(3) issuance by the PNE to the investor of a number of hearts equal to the payment amount divided by the heart price; the investor thereby becoming a heart holder;
wherein the PNE maintains a record of each investor and the number of hearts purchased by the investor; the total number of hearts issued by the PNE at a particular time being called the total hearts, hereinafter identified by the acronym TH;
(d) a means for an investor to designate heart beneficiaries comprising two steps:
(1) the investor making one or more designations of SNEs to benefit from hearts issued to the investor, each designation comprising the identity of one SNE and a number of hearts from which it will benefit, the total number of hearts in all the designations by the investor not exceeding the total number of hearts issued to the investor; and
(2) the investor communicating each such designation to the PNE;
wherein the PNE maintains a record of each designation, including the name of the investor making it, the name of the designated SNE and the number of hearts designated to it; and
(e) a means to allocate and distribute funds in a manner that is related to hearts, which is also called the allocation and distribution means; the allocation and distribution means comprising three nonprofit distribution steps:
(1) the first nonprofit distribution step being a determination of a total amount of grants to distribute to the SNEs, which amount is also called the total grants and is hereinafter identified by the acronym TG; said step comprising two sub-steps:
(i) the first sub-step being allocation, at a particular time, by the PNE of a total amount of money for investment returns, which is also called the noncommercial allocation for investment returns, hereinafter identified by the acronym NCAIR; said particular time also being called the PNE allocation time; and
(ii) the second sub-step being calculation of TG; the default value of TG simply being NCAIR;
(2) the second nonprofit distribution step being the calculation, for each SNE, of an amount of a grant to be paid to such SNE; parameters to such calculation including TG, TH at the PNE allocation time, and the number of hearts designated in one or more designations to benefit such SNE; and
(3) the third nonprofit distribution step being payment by the PNE of grants to each SNE in the amount calculated for the SNE;
wherein, as to the allocation and distribution means, the PNE maintains a record of NCAIR and the PNE allocation time, performs said calculations, and maintains a record of the results thereof;
whereby, as to the system for raising funds, the PNE raises funds by selling hearts to investors, and subsequently pays any investment returns on the basis of the hearts, free from any legal obligation either to register the offering under securities laws, or to rely on an exemption from such registration, because the hearts lack the indispensable characteristic of a security.

2. The fund-raising system of claim 1 additionally comprising a project undertaken by the PNE; the nature of the project being consistent with the PNE's nonprofit purposes; the project having the potential to generate income; the funds raised by the heart investment offering being used to finance the project; investors purchasing hearts in the hope that the project will generate future income that will benefit their designated SNEs; some or all of the income generated by the project, when and if such income materializes, being allocated for grants in the first nonprofit distribution step.

3. The fund-raising system of claim 1 additionally comprising
(a) computer system hardware and software, the computer system hardware being a personal computer, a smartphone, a server computer or other type of computing hardware; the computer system software causing the computer system hardware to maintain electronic records and to perform calculations; the records maintained by the PNE and the calculations done by the PNE being maintained and done, respectively, by the computer system.
(b) one or more heart certificates; each heart certificate being a paper certificate, an electronic certificate, a receipt or another representation that the PNE has issued hearts to a heart holder and that includes the name of the PNE, the name of the heart holder and the number of hearts that are issued; the PNE delivering the heart certificate to the heart holder after issuance of the hearts.

4. The fund-raising system of claim 1 wherein the allocation and distribution means causes the distribution of the grants to be done in proportion to the hearts; said proportionate distribution being accomplished by calculating the amount of the grant paid to a particular SNE to be equal to TG times the number of hearts assigned to such SNE divided by TH.

5. The fund-raising system of claim 1 wherein the PNE is a tax-exempt entity, donations to which are tax-deductible for the donor, the investments in hearts being donations to the PNE that are tax-deductible to heart investors.

6. The fund-raising system of claim 1 wherein the PNE publishes an advertisement for the heart investment offering in a newspaper, magazine, flyer, mailer, or other print medium, or on radio or television, or on the Internet or by any other means.

7. The fund-raising system of claim 1 wherein a heart holder is permitted, from time to time, to notify the PNE of changes in the heart holder's designation of hearts to SNEs; the PNE maintaining a record of the change.

8. The fund-raising system of claim 1 further comprising:
(a) a for-profit legal entity, hereinafter identified by the acronym FPE; the FPE being a for-profit corporation, a limited liability company, a joint stock company, a partnership, a business trust, or another type of for-profit legal entity; and
(b) shares in the for-profit legal entity, the shares being shares of stock, membership interests, partnership interests or other form of owner interest appropriate for the type of the FPE; a payment that is made to the owners of the shares on the basis of the number of shares owned being herein called a dividend regardless of the type of the FPE or the type of shares; an owner of one or more shares also being called a stockholder; the total number of shares that have been issued by the FPE at a particular time being called the total shares, hereinafter identified by the acronym TS;
wherein:
(c) the first sub-step of the first nonprofit distribution step has the additional characteristic that NCAIR is comprised of two components: a first grant part, hereinafter identified by the acronym G1, and a usage fee, hereinafter identified by the acronym UF; G1 being related to hearts, and UF being related to shares;
(d) the allocation and distribution means further comprises five for-profit distribution steps:
(1) the first for-profit distribution step being a determination, at a particular time, by the FPE of a total amount of money that it will allocate for investment returns, said total amount of money also being called the commercial allocation for investment returns, hereinafter identified by the acronym CAIR; said particular time also being called the FPE allocation time; the CAIR being comprised of two components: a first provisional dividend part, hereinafter identified by the acronym PD1; and a grant package, hereinafter identified by the acronym GP; PD1 being related to shares, and GP being related to hearts;
(2) the second for-profit distribution step being the calculation of the values of PD1 and GP; the parameters to the calculation of PD1 including CAIR, TS and TH; the parameters to the calculation of GP also including CAIR, TS and TH;
(3) the third for-profit distribution step being the calculation of an amount of total provisional dividends to distribute to the stockholders, hereinafter identified by the acronym TPD; the parameters to the calculation of TPD including PD1 and an after-tax usage fee, hereinafter identified by the acronym ATXUF; the ATXUF being related to the UF and the impact of UF on FPE's income taxes;
(4) the fourth for-profit distribution step being the calculation of an amount of a payment to be made to each stockholder on the basis of TPD and the number of shares owned by such stockholder; and
(5) the fifth for-profit distribution step being payment by the FPE of dividends to each stockholder in the amounts so calculated and the payment to the PNE of the amount of GP;
wherein, as to the five for-profit distribution steps, the FPE maintains a record of the owners of the shares, the number of shares owned by each and CAIR, performs said calculations, and maintains a record of the results thereof;
(e) the second sub-step of the first nonprofit distribution step has the additional characteristics that the parameters to the calculation of TG include NCAIR, UF and GP; and
(f) the third nonprofit distribution step further comprises the payment by the PNE of UF to the FPE.

9. The fund-raising system of claim 8 wherein:
(a) the PNE and the FPE coordinate their allocation for investment returns so that the PNE and FPE allocation times are approximately the same or are in the same accounting period; and
(b) of the PNE and the FPE, one can elect not to make an allocation for investment returns when the other makes an allocation for investment returns; if the PNE elects not to do so, then NCAIR is zero, and if the FPE elects not to do so, then CAIR is zero.

10. The fund-raising system of claim 8 wherein:
(a) prior to the first nonprofit distribution step and prior to the first for-profit distribution step, three values are calculated:
(1) the total hearts and shares, hereinafter identified by the acronym THS, is set equal to TH plus TS;
(2) the heart fraction, hereinafter identified by the acronym HF, is set equal to TH divided by THS; and
(3) the share fraction, hereinafter identified by the acronym SF, is set equal to TS divided by THS;
(b) in the first sub-step of the first nonprofit distribution step:
(1) G1 is set equal to NCAIR times HF; and
(2) UF is set equal to NCAIR times SF;
(c) in the first for-profit distribution step:
(1) PD1 is set equal to CAIR times SF; and
(2) GP is set equal to CAIR times HF;
(d) in the second sub-step of the first nonprofit distribution step, TG is set equal to G1 plus GP;
(e) in the second for-profit distribution step:
(1) ATXUF is set equal to UF minus any income-tax liability incurred by the FPE arising from its receiving UF; and
(2) TPD is set equal to PD1 plus ATXUF;
(f) in the second nonprofit distribution step, the amount of the grant paid to a particular SNE is set equal to TG times the number of hearts assigned to such SNE divided by TH; the distribution of the grants thereby being in proportion to the hearts, and
(g) in the third for-profit distribution step, the amount of the dividend paid to a particular stockholder is set equal to TPD times the number of shares owned by such stockholder divided by TS; the distribution of the dividends thereby being in proportion to the shares.

11. The fund-raising system of claim 8 wherein the computer system hardware comprises two distinct hardware systems, one of which is operated by the PNE, the other of which is operated by the FPE, both of which run similar or identical copies of the computer system software; the two hardware systems being interconnected via the Internet or other interconnection means; the values of TH, TS, UF and GP being shared across the interconnection.

12. The fund-raising system of claim 8 further comprising:
(a) a partnering agreement, which is an agreement between the PNE and the FPE wherein, for monetary or other consideration from the PNE, the FPE agrees to pay a grant package, i.e. GP, to the PNE whenever the FPE distributes dividends to the owners of its shares; and
(b) a licensing agreement, which is an agreement between the PNE and the FPE wherein, for a license to use property owned by the FPE, the PNE agrees to pay a usage fee, i.e. UF, to the FPE whenever it distributes grants to the SNEs.

13. The fund-raising system of claim 12 further comprising:
(a) intellectual property, all or part of which is developed by the PNE;
(b) a product that is a tangible product, an intangible product or a service; the product containing the intellectual property and/or being produced by methods that utilize the intellectual property; the nature of the product being consistent with the PNE's nonprofit purposes; and
(c) a plurality of customers; the PNE selling the product to a first customer; the FPE selling the product to a second customer;
wherein:
(d) the partnering agreement conveys all or part of the intellectual property from the PNE to the FPE in exchange for the grant packages, i.e. GP; and
(e) the licensing agreement grants the PNE a license to the intellectual property in exchange for royalties; the royalties being the usage fees, i.e. UF.

14. The fund-raising system of claim 13 wherein the licensing agreement divides the market for the product into two categories of customers:
(a) the first category being customers to whom the PNE can sell the product as a legitimate activity within the scope of its nonprofit purposes; the license granted to the PNE being to sell the product to such customers; and
(b) the second category being all other customers; the licensing agreement providing that the FPE retains the right to sell the product to such customers.

15. The fund-raising system of claim 13 further comprising:
(a) an additional legal entity whose purpose is to hold the intellectual property and to thereby shield it from lawsuits against the PNE or FPE; said entity being called the intellectual property holding entity, hereinafter identified by the acronym IPHE; and
(b) an intellectual property holding agreement between the FPE and the IPHE, wherein the FPE conveys the intellectual property to the IPHE in exchange for an exclusive license to use and to sublicense the intellectual property;
wherein the license granted to the PNE by the licensing agreement constitutes a sublicense.

16. The fund-raising system of claim 13 wherein:
(a) a project is jointly undertaken by the PNE and FPE; the project including development and/or marketing of the product; the nature of the portion of the project for which the PNE is responsible being consistent with its nonprofit purposes; the funds raised by the heart investment offering being used to finance the project; investors purchasing hearts in the hope that the project will generate future income that will benefit their designated SNEs; some or all of the PNE's income from the project, when and if such income materializes, being allocated for investment returns in first nonprofit distribution step; some or all of the FPE's income from the project, when and if such income materializes, being allocated for investment returns in first for-profit distribution step;
(b) the PNE is a tax-exempt entity, donations to which are tax-deductible for the donor, the investments in hearts being donations to the PNE that are tax-deductible to heart investors;
(c) the PNE publishes an advertisement for the heart investment offering in a newspaper, magazine, flyer, mailer, or other print medium, or on radio or television, or on the Internet or by any other means;
(d) a heart holder is permitted, from time to time, to notify the PNE of changes in the heart holder's designation of hearts to secondary nonprofit entities;
(e) the FPE is permitted to raise additional money to finance the project through sale of the stock in compliance with securities laws;
(f) the PNE and the FPE coordinate their distributions to investors so that the PNE and FPE allocation times are approximately the same or are in the same accounting period;
(g) prior to the first nonprofit distribution step and prior to the first for-profit distribution step, three values are calculated:
(1) the total hearts and shares, hereinafter identified by the acronym THS, is set equal to TH plus TS;
(2) the heart fraction, hereinafter identified by the acronym HF, is set equal to TH divided by THS; and
(3) the share fraction, hereinafter identified by the acronym SF, is set equal to TS divided by THS;
(h) in the first sub-step of the first nonprofit distribution step:
(1) G1 is set equal to NCAIR times HF; and
(2) UF is set equal to NCAIR times SF;
(i) in the first for-profit distribution step:
(1) PD1 is set equal to CAIR times SF; and
(2) GP is set equal to CAIR times HF;
(j) in the second sub-step of the first nonprofit distribution step, TG is set equal to G1 plus GP;
(k) in the second for-profit distribution step:
(1) ATXUF is set equal to UF minus any income-tax liability incurred by the FPE arising from its receiving UF; and
(2) TPD is set equal to PD1 plus ATXUF;
(l) in the second nonprofit distribution step, the amount of the grant paid to a particular SNE is set equal to TG times the number of hearts assigned to such SNE divided by TH; the distribution of the grants thereby being in proportion to the hearts, and
(m) in the third for-profit distribution step, the amount of the dividend paid to a particular stockholder is set equal to TPD times the number of shares owned by such stockholder divided by TS; the distribution of the dividends thereby being in proportion to the shares.

17. A method of raising funds by selling investment units to investors, and subsequently paying investment returns on the basis of the investment units, that does not involve a security; a security being a share of stock or other investment unit regulated by securities laws; an indispensable characteristic of a security being the potential for the owner of the security to receive money or other valuable assets from the issuer of the security or upon the issuer's dissolution; the method for raising funds comprising the steps of:
(a) identifying a primary nonprofit legal entity, hereinafter identified by the acronym PNE, that will raise the funds;
(b) offering hearts for sale to prospective investors at a heart price denominated in dollars per heart or another monetary unit per heart; the hearts being the investment units; the offering being conducted by the PNE; each heart comprising a right to control a portion of a distribution of nonprofit grants;
(c) purchasing, by an investor from the PNE, one or more hearts; optionally repeating this step for additional heart purchases by the same investor or other investors;
(d) issuing, by the PNE to each investor a number of hearts equal to the payment amount divided by the heart price; the investor thereby becoming a heart holder; the total number of hearts issued by the PNE at a particular time being called the total hearts, hereinafter identified by the acronym TH;
(e) designating, by each investor, one or more secondary nonprofit entities to benefit from hearts issued to the investor, the secondary nonprofit entities hereinafter identified individually by the acronym SNE and collectively by the pluralized acronym SNEs; the total number of hearts designated by an investor not exceeding the total number of hearts issued to the investor;
(f) communicating, by each investor to the PNE, each such designation;
(g) determining a total amount of grants to distribute to the SNEs, which amount is also called the total grants and is hereinafter identified by the acronym TG; this step comprising two sub-steps:
(1) allocating, by the PNE at a particular time, a total amount of money for investment returns, which is also called the noncommercial allocation for investment returns, hereinafter identified by the acronym NCAIR; said particular time also being called the PNE allocation time; this sub-step being called the PNE allocation sub-step; and
(2) calculating TG; the default value of TG simply being NCAIR; this sub-step being called the TG calculation sub-step;
(h) calculating, for each SNE, an amount of a grant for the PNE to pay to such SNE; the parameters to the calculation the grant to be paid to such SNE including TG, TH at the PNE allocation time, and the number of hearts designated in one or more designations to benefit such SNE; this step being called the investment return calculation step; and
(i) paying, by the PNE, of grants to each SNE in the amount calculated for the SNE;
whereby the PNE raises funds by selling hearts, and subsequently pays any investment returns on the basis of the hearts, free from any legal obligation either to register the offering under securities laws, or to rely on an exemption from such registration, because the hearts lack the indispensable characteristic of a security.

18. Apparatus for practicing the method of claim 17 comprising:
(a) computer system hardware and software that records the transactions and performs the calculations specified in the steps of said method; and
(b) one or more heart certificates; each heart certificate being a paper certificate, an electronic certificate, a receipt or another representation that the PNE has issued hearts to a heart holder and that includes the name of the PNE, the name of the heart holder and the number of hearts that are issued; the PNE delivering the heart certificate to the heart holder after issuance of the hearts.

19. The method of claim 17 further comprising the steps of:
(a) identifying a for-profit legal entity, hereinafter identified by the acronym FPE; ownership interests in which are herein called shares regardless of whether they are shares of stock, membership interests, partnership interests or other form of owner interest appropriate for the type of the FPE; an owner of one or more shares also being called a stockholder; a payment that is made to the stockholders on the basis of the number of shares owned being herein called a dividend regardless of the type of the FPE or the type of share; the total number of shares issued by the FPE at a particular time being called the total shares, hereinafter identified by the acronym TS;
(b) allocating, by the FPE at approximately the same time or within the same accounting period as the PNE allocation sub-step, a total amount of money for investment returns, which is also called the commercial allocation for investment returns, hereinafter identified by the acronym CAIR;
(c) executing, by the PNE and the FPE, a partnering agreement wherein, in exchange for intellectual property transferred from the PNE to the FPE, the FPE agrees to pay a grant package, hereinafter identified by the acronym GP, to the PNE whenever the FPE distributes dividends to the owners of its shares;
(d) executing, by the PNE and the FPE, a licensing agreement, wherein, for a license to use intellectual property owned by the FPE, the PNE agrees to pay a usage fee, hereinafter identified by the acronym UF, also called a royalty, to the FPE whenever it distributes grants to the SNEs;
(e) developing a product containing the intellectual property and/or being produced by methods that utilize the intellectual property; the nature of the product being consistent with the PNE's nonprofit purposes;
(f) selling the product to plurality of customers; the PNE selling the product to customers to whom the PNE can sell the product as a legitimate activity within the scope of its nonprofit purposes; the FPE selling the product to other customers;
(g) calculating, before the TG calculation sub-step:
(1) a total hearts and shares, hereinafter identified by the acronym THS, equal to TH plus TS;
(2) a heart fraction, hereinafter identified by the acronym HF, equal to TH divided by THS;
(3) a share fraction, hereinafter identified by the acronym SF, equal to TS divided by THS;
(4) a first grant part, hereinafter identified by the acronym G1, equal to NCAIR times HF;
(5) UF equal to NCAIR times SF;
(6) a first provisional dividend part, hereinafter identified by the acronym PD1, equal to CAIR times SF;
(7) GP equal to CAIR times HF; and
(8) an after-tax usage fee, hereinafter identified by the acronym ATXUF, equal to UF minus any income-tax liability incurred by the FPE arising from its receiving UF;
(h) calculating, within the TG calculation sub-step:
(1) TG equal to G1 plus GP; and
(2) an amount of total provisional dividends, hereinafter identified by the acronym TPD, equal to PD1 plus ATXUF;
(i) calculating, within the investment return calculation step:
(1) the amount of the grant paid to a particular SNE equal to TG times the number of hearts assigned to such SNE divided by TH; and
(2) an amount of dividend paid to a particular stockholder equal to TPD times the number of shares owned by such stockholder divided by TS;
(j) paying, by the FPE, of dividends to each stockholder in the amount so calculated for the stockholder.

20. Apparatus for practicing the method of claim 19 comprising:
(a) computer system hardware and software that records the transactions and performs the calculations specified in the steps of said method;
(b) a paper or electronic document memorializing the partnering agreement, duly signed by the PNE and the FPE;
(c) a paper or electronic document memorializing the licensing agreement, duly signed by the PNE and the FPE;
(d) a paper or electronic document constituting a prospectus, offering circular or other document, hereinafter called the prospectus, detailing the heart offering for prospective investors, including the name of the PNE, the price of the hearts, a disclosure of the nature of the project, the product, its market potential, how the heart system works, the investment risks and the procedure for an investor to invest in hearts; the prospectus being delivered to prospective investors upon request;
(e) an advertisement suitable for publication that announces the heart offering and provides contact information for learning more about the heart offering, including how to obtain a copy of the prospectus; said advertisement being published in a newspaper, magazine, flyer, mailer, or other print medium, or on radio or television, or on the Internet or by any other means; and
(f) one or more heart certificates; each heart certificate being a paper certificate, an electronic certificate, a receipt or another representation that the PNE has issued hearts to a heart holder and that includes the name of the PNE, the name of the heart holder and the number of hearts that are issued; the PNE delivering the heart certificate to the heart holder after issuance of the hearts.
